(19) United States
(12) Patent Application Publication
(10) Pub. No.: US 2017/0142326 A1
(43) Pub. Date: May 18, 2017

(54) IMAGE CAPTURE METHOD AND APPARATUS

(71) Applicant: NUBIA TECHNOLOGY CO., LTD., Shenzhen, Guangdong (CN)

(72) Inventor: Tanwen Huang, Shenzhen (CN)

(21) Appl. No.: 15/321,867

(22) PCT Filed: Jun. 8, 2015
(86) PCT No.: PCT/CN2015/081017

§ 371 Date: Dec. 23, 2016

(30) Foreign Application Priority Data
Jun. 25, 2014 (CN) 201410293327.2

(51) Int. Cl. H04N 5/232

(52) U.S. Cl. CPC H04N 5/23216; H04N 5/23293

(57) ABSTRACT

An image capture method and apparatus, comprising the steps: activating a camera module and entering a background-running image capture mode; in the background running image capture mode, controlling the operation of the camera module in the background; and, when the camera module is running in the background, receiving an image capture command and executing same.

### TECHNICAL FIELD

The disclosure relates to the technical field of image pickup, and in particular to a shooting method and apparatus.

### BACKGROUND

In order to meet life recording demands of people, there are more and more devices having recording functions, including cameras, mobile phones, video cameras, computers, laptops and the like, all of which are shooting apparatuses having shooting functions. Photographing and video-recording based on the shooting functions of the aforementioned devices have become the most convenient and most intuitive recording way.

In the conventional art, during shooting by a shooting apparatus, a screen of the shooting apparatus will display a shooting interface for a user to preview. Once the user exits the shooting interface, shooting is stopped or ended, and the shooting function cannot be used. A shooting method capable of closing camera preview is proposed in Chinese Patent application CN201310343019.1, in which the screen does not display the shooting interface during shooting and is in a black screen state instead. However, based on the above method, the shooting interface still occupies the screen during shooting, and merely in this case, the shooting interface is a black screen instead of a preview interface.

To sum up, during shooting by a conventional shooting apparatus, a camera module thereof only runs in the foreground, and occupies a current screen. Once exiting the current screen, the user cannot use the shooting function. Therefore, during shooting by the conventional shooting apparatus, other functions cannot be used at the same time, thus being not good for improving the operation efficiency. Each time when shooting is performed, it is necessary to start a camera module or switch the camera module to the foreground so as to be capable of performing shooting, so the image capturing speed is low.

### SUMMARY

A main objective of the disclosure is to provide a shooting method and apparatus. The disclosure is intended to achieve using of other functions of a shooting apparatus at the same time of shooting, thus improving the operation efficiency.

To this end, the embodiments of the disclosure provide a shooting method, including:

a camera module is started, and a background shooting mode is entered;

in the background shooting mode, the camera module is controlled to run in the background; and

The camera module running in the background receives and executes a shooting instruction.

In an embodiment, the step that the background shooting mode is entered may include:

after the camera module is started, the background shooting mode is automatically entered; or

after the camera module exits a shooting interface, the background shooting mode is automatically entered; or

the camera module enters the background shooting mode according to an operation instruction.

In an embodiment, the step that the camera module running in the background receives and executes a shooting instruction may include:

Upon triggering of a preset key, a background control module releases a broadcast according to a key triggering event; and

the camera module running in the background receives the broadcast, acquires the key triggering event, takes the key triggering event as the shooting instruction, and executes the shooting instruction.

In an embodiment, the method may further include: when the camera module runs in the background, a processing module processes user's operations on other applications or programs.

The embodiments of the disclosure also provide a shooting apparatus, including a processing module, a camera module and a background control module, in which:

the processing module is configured to start the camera module;

the camera module is configured to enter a background shooting mode, and receive and execute a shooting instruction when running in the background; and

the background control module is configured to control the camera module to run in the background when the camera module enters the background shooting mode.

In an embodiment, the camera module may be configured to:

automatically enter the background shooting mode after being started; or,

automatically enter the background shooting mode after exiting a shooting interface; or,

enter the background shooting mode according to an operation instruction.

In an embodiment, the background control module may be configured to: release, upon triggering of a preset key, a broadcast according to a triggering event; and

the camera module may be configured to: receive the broadcast when running in the background, acquire the triggering event, take the triggering event as the shooting instruction and execute the shooting instruction.

In an embodiment, the processing module may be further configured to: process, when the camera module runs in the background, user's operations on other applications or programs.

In the shooting method according to the present disclosure, by adding a background shooting mode, a camera module runs in the background, and the camera module running in the background receives and executes a shooting instruction. Thus, a user may perform shooting while using other functions of a shooting apparatus, two activities do not conflict mutually, and the operation efficiency is improved. Moreover, when processing a great number of pictures shot in real time, the user may perform shooting and processing simultaneously, thereby improving the efficiency, and saving time and effort. Furthermore, since the camera module runs in the background, it is unnecessary to turn a screen on during shooting, and therefore quick image capturing may be implemented.

### BRIEF DESCRIPTION OF THE DRAWINGS

FIG. 1 is a flowchart of a first embodiment for a shooting method according to the disclosure;

FIG. 2 is a flowchart of a second embodiment for a shooting method according to the disclosure; and

FIG. 3 shows a structural diagram of a shooting apparatus according to an embodiment of the disclosure.

Achievement of objectives, functional features and advantages of the disclosure will be further illustrated with reference to the drawings in conjunction with embodiments.

### DETAILED DESCRIPTION

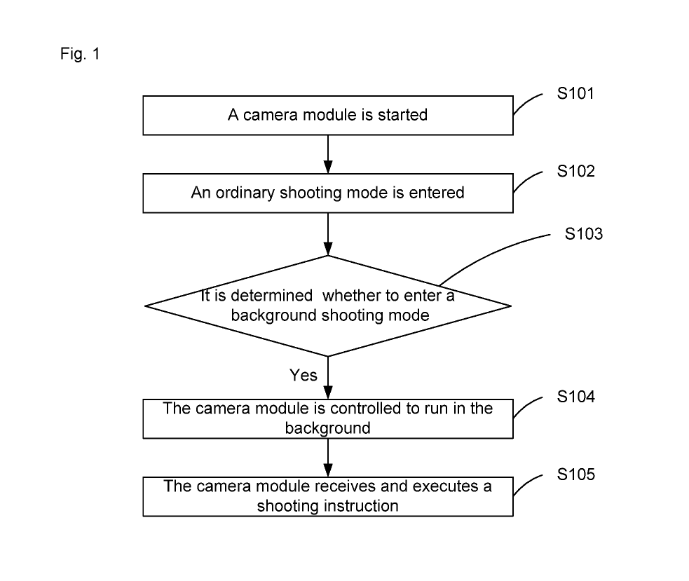

Referring to FIG. 1, a first embodiment for a shooting method according to the disclosure is provided. The shooting method includes the steps as follows.

Step S101: A camera module is started.

As for a camera device, when the device is switched on, the camera module is automatically started. As for a terminal device having an image pickup function, when a camera application or program is opened, the camera module is started.

Step S102: An ordinary shooting mode is entered.

The ordinary shooting mode refers to: displaying a shooting interface (including a preview picture prior to shooting or in a shooting process) on a screen, and taking the shooting interface as a current interface of a shooting apparatus. In this case, the camera module runs in the foreground.

An android system is taken as an example. In the ordinary shooting mode, shooting and preview are implemented by means of an Activity assembly, herein the Activity is an application program assembly, provides a screen or an interactive interface, and interacts with a user to fulfil a certain task. All operations in the Activity are closely related to the user. The Activity is an assembly in charge of interacting with the user. A specified control may be displayed by means of setContentView(View). In an android application, an Activity is generally an independent screen, which may display some controls and may monitor and process events of the user to make a response. Activities communicate by means of Intent.

Step S103: It is determined whether to enter a background shooting mode.

Specifically, the background shooting mode may be entered according to an operation instruction of the user before shooting or in a shooting process. For example, a background shooting mode option is displayed on the shooting interface. When the user selects the option, the ordinary shooting mode is exited, and the background shooting mode is entered. Or, the background shooting mode is triggered by triggering a specific functional key or a preset touch or gesture action.

The background shooting mode may be automatically entered after the shooting apparatus exits the shooting interface. For example, before shooting or in the shooting process, the shooting interface is exited, a main interface or other application interfaces of the terminal device are entered, or a lock screen state, a standby state or a screen off state is presented, and in this case, the camera module automatically enters the background shooting mode.

Step S104: The camera module is controlled to run in the background.

After the background shooting mode is entered, a background control module controls a camera to run in the background.

Specifically, an android system is taken as an example. When the ordinary shooting mode is exited, the camera module in an Activity is closed, and a current interface is no longer displayed as a shooting interface. The background control module controls the camera module to run in background service, a setPreviewTexture( )interface built in the camera module is used, and one parameter SurfaceTexture needed therein may be randomly created. Since it is unnecessary to display a preview picture, the created category does not need to perform any processing. Thus, the shooting function of the camera module may be continuously used.

Step S105: The camera module receives and executes a shooting instruction.

The user may release the shooting instruction by triggering preset keys such as a camera key, an earphone key, a volume key, a Bluetooth key or other physical keys, and the shooting instruction may be released by a single or double click on one of the keys or a combination of the plurality of keys. The keys include built-in keys of the shooting apparatus or external keys. When the camera module runs in the background, a processing module processes user's operations on other applications or programs simultaneously.

Specifically, when the preset keys are triggered, although a response cannot be obtained from the background service, a response is made in a PhoneWindowManager of an original local framework layer where a triggering event occurs. Thus, when detecting that the preset keys are triggered, the background control module releases a broadcast according to the triggering event, such that a response event is made using a broadcast Intent and received by the camera module running in the background. A broadcast receiver is registered in the camera module in advance, and the broadcast may be received by means of the receiver, such that the triggering event is acquired, and taken as the shooting instruction to be executed, such as picture shooting, starting video shooting and ending video shooting.

Since the camera module runs in the background in the background shooting mode, the preview interface is not needed, and therefore the user may perform shooting while using other functions of the shooting apparatus. For example, when it is necessary to take a long time to continuously shoot a great number of pictures so as to combine the pictures and make gif and short videos, interval burst shooting is used. For example, interval time is set as 30 s (the interval time should be shorter if a finer effect is desired). In this case, if the ordinary shooting mode is used, pictures can be selected from a gallery and combined after shooting is completed, and the manufacturing efficiency is lower. However, if it is switched to the background shooting mode in the shooting process, since the camera module runs in the background, the user may get access to the gallery and select the shot pictures, simultaneous shooting and selecting may be implemented, the pictures are completely selected after shooting is completed, the pictures are directly combined, and gif or short videos are manufactured, thereby improving the manufacturing efficiency.

Furthermore, since the camera module runs in the background, the screen is not necessarily to be turned on. Thus, the advantage of quick shooting is provided. For example, after the camera module is started, the user turns the screen off and puts the shooting apparatus away. In this case, the camera module automatically enters the background shooting mode and runs in the background. When the user needs to capture a certain scenery or object, the user directly takes the shooting apparatus out and triggers the preset keys to perform shooting without the steps of turning the screen on, unlocking and starting the camera module, thereby greatly increasing the image capturing speed.

Since the camera module running in the background service is a Service, it is unnecessary to arrange a switch only in the camera module. The switch may be arranged at any places such as system setting.

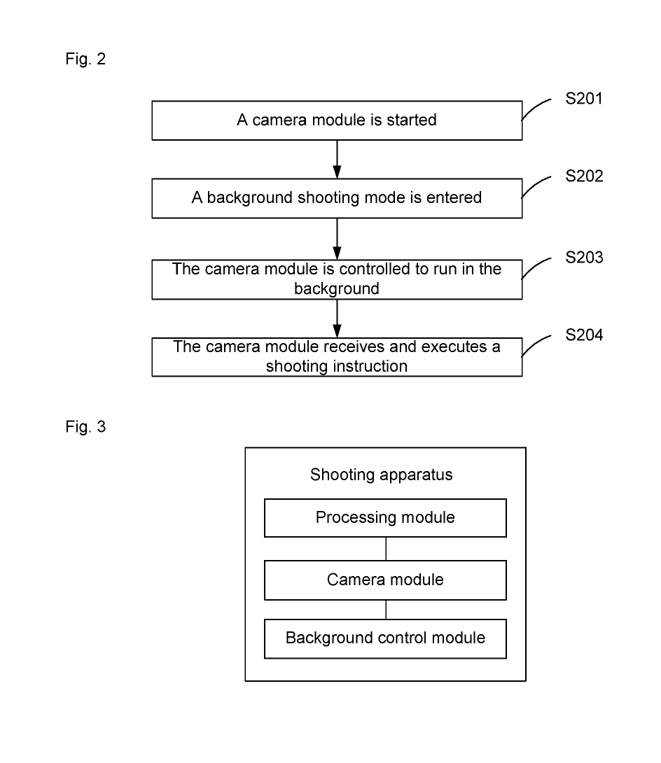

Referring to FIG. 2, a second embodiment for a shooting method according to the disclosure is provided. The shooting method includes the steps as follows.

Step S201: A camera module is started.

In this embodiment, a shooting apparatus may start the camera module under any situations. For example, the shooting apparatus is under a lock screen state, a standby state or a screen off state currently or a current screen displays a main interface or other application interfaces. The camera module may be started by means of a specific functional key or a preset operation instruction such as a gesture action.

Step S202: A background shooting mode is entered.

After the camera module is started, the background shooting mode is immediately and automatically entered.

Step S203: The camera module is controlled to run in the background.

Step S204: The camera module receives and executes a shooting instruction.

Thus, a user may start the camera module anytime and anywhere to shoot in the background, the shooting speed is increased, and there is no conflict against other functions which are being used on the shooting apparatus currently.

Referring to FIG. 3, an embodiment for a shooting apparatus according to the disclosure is provided. The shooting apparatus includes a processing module, a camera module and a background control module.

The processing module is configured to start a camera module. Specifically, if the shooting apparatus is a camera device, when the device is opened, the processing module automatically starts the camera module. If the shooting apparatus is a terminal device having an image pickup function, when a camera application or program is opened, the processing module starts the camera module.

When the camera module runs in the background, the processing module processes user's operations on other applications or programs simultaneously.

The camera module is configured to select a shooting mode, and receives and executes a shooting instruction.

Wherein, the shooting mode includes an ordinary shooting mode and a background shooting mode. The ordinary shooting mode refers to: displaying a shooting interface (including a preview picture prior to shooting or in a shooting process) on a screen, and taking the shooting interface as a current interface of a shooting apparatus. In this case, the camera module runs in the foreground.

As for the background shooting mode, the camera module runs in the background. The camera module may enter the background shooting mode according to an operation instruction of the user before shooting or in a shooting process. The camera module may automatically enter the background shooting mode after the shooting apparatus exits the shooting interface.

Generally, after being started, the camera module automatically enters the ordinary shooting mode, and then is switched to the background shooting mode according to a preset rule. In some embodiments, after being started, the camera module automatically enters the background shooting mode, and then is switched to the ordinary shooting mode according to the operation instruction.

The background control module is configured to control, when the camera module enters the background shooting mode, the camera module to run in the background.

Receiving, when the camera module runs in the background, the shooing instruction is implemented by means of the ways as follows.

The user may release the shooting instruction by triggering preset keys such as a camera key, an earphone key, a volume key, a Bluetooth key or other physical keys, and the shooting instruction may be released by a single or double clicks on one of the keys or a combination of the plurality of keys. The keys include built-in keys of the shooting apparatus or external keys. When the preset keys are triggered, although a response cannot be obtained from the background service, a response is made in a PhoneWindowManager of an original local framework layer where a triggering event occurs. Thus, when detecting that the preset keys are triggered, the background control module releases a broadcast according to the triggering event, such that a response event is made using a broadcast Intent and received by the camera module running in the background. A broadcast receiver is registered in the camera module in advance, and the broadcast may be received by means of the receiver, such that the triggering event is acquired, and taken as the shooting instruction to be executed, such as picture shooting, starting video shooting and ending video shooting.

It is important to note that the technical features in the above method embodiment are correspondingly applicable in the apparatus, which will not be elaborated herein.

Accordingly, in the shooting apparatus of the disclosure, by adding a background shooting mode, a camera module runs in the background, and the camera module running in the background receives and executes a shooting instruction. Thus, a user may perform shooting while using other functions of a shooting apparatus, two activities do not conflict mutually, and the operation efficiency is improved. Moreover, when processing a great number of pictures shot in real time, the user may perform shooting and processing simultaneously, thereby improving the efficiency, and saving time and effort. Furthermore, since the camera module runs in the background, it is unnecessary to turn a screen on during shooting, and therefore quick image capturing may be implemented.

It is important to note that shooting by the shooting apparatus provided by the above embodiment is only illustrated with all the above divided functional modules. In practical application, the functions may be allocated to and implemented by different functional modules as needed. That is, the internal structure of the shooting apparatus is divided into different functional modules so as to complete all or some of the functions described above. In addition, the shooting apparatus provided by the above embodiment and the embodiment for the shooting method belong to the same concept, and a specific implementation process is detailed in the method embodiment, which will not be elaborated herein.

Those skilled in the art may understand that all or some of the steps in the above embodiment method may be implemented by controlling relevant hardware via programs, the programs may be stored in a computer readable storage medium, and the storage medium may be a Read-Only Memory/Random Access Memory (ROM/RAM), a magnetic disk or an optical disk.

It will be understood that the above is only the preferred embodiments of the disclosure and cannot limit the patent scope of the disclosure accordingly. Equivalent structure or equivalent flow transformations made using the description and drawings of the disclosure or direct or indirect applications to other relevant technical fields may fall within the patent protection scope of the disclosure in the same way.

Those skilled in the art may understand that all or some of the steps in the above embodiment method may be implemented by hardware relevant to program instructions, the programs may be stored in a computer readable storage medium, and when the programs are executed, the steps in the above method embodiment are also executed. The storage medium includes: various media capable of storing program codes such as a mobile storage device, an ROM, an RAM, a magnetic disk or an optical disk.

The above is only specific implementations of the disclosure. However, the protective scope of the disclosure is not limited thereto. Those skilled in the art may easily think of variations or replacements within the disclosed technical scope of the disclosure. These variations or replacements shall fall within the protective scope of the disclosure. Therefore, the protective scope of the disclosure shall refer to the protective scope of the claims.

1. A shooting method, comprising:
starting a camera module, and entering a background shooting mode;
controlling, in the background shooting mode, the camera module to run in the background; and
receiving and executing, by the camera module running in the background, a shooting instruction.

2. The shooting method according to claim 1, wherein entering the background shooting mode comprises:
automatically entering, by the camera module after being started, the background shooting mode; or,
automatically entering, by the camera module after exiting a shooting interface, the background shooting mode; or,
entering, by the camera module, the background shooting mode according to an operation instruction.

3. The shooting method according to claim 1, wherein receiving and executing, by the camera module during its background running, the shooting instruction comprises:
upon triggering of a preset key, releasing, by a background control module, a broadcast according to a key triggering event; and
receiving, by the camera module running in the background, the broadcast, acquiring the key triggering event, taking the key triggering event as the shooting instruction and executing the shooting instruction.

4. The shooting method according to claim 1, further comprising: processing operations on other applications or programs when the camera module runs in the background.

5. A shooting apparatus, comprising: a processing module, a camera module and a background control module,
wherein the processing module is configured to start the camera module;
the camera module is configured to enter a background shooting mode, and receive and execute a shooting instruction when running in the background; and
the background control module is configured to control the camera module to run in the background when the camera module enters the background shooting mode.

6. The shooting apparatus according to claim 5, wherein the camera module is configured to:
automatically enter the background shooting mode after being started; or,
automatically enter the background shooting mode after exiting a shooting interface; or,
enter the background shooting mode according to an operation instruction.

7. The shooting apparatus according to claim 5, wherein the background control module is configured to release, upon triggering of a preset key, a broadcast according to a key triggering event; and
the camera module is configured to receive the broadcast when running in the background, acquire the key triggering event, take the key triggering event as the shooting instruction and execute the shooting instruction.

8. The shooting apparatus according to claim 5, wherein the processing module is further configured to process, when the camera module runs in the background, user's operations on other applications or programs.

9. The shooting method according to claim 2, further comprising: processing operations on other applications or programs when the camera module runs in the background.

10. The shooting method according to claim 3, further comprising: processing operations on other applications or programs when the camera module runs in the background.

11. The shooting apparatus according to claim 6, wherein the processing module is further configured to process, when the camera module runs in the background, user's operations on other applications or programs.

12. The shooting apparatus according to claim 7, wherein the processing module is further configured to process, when the camera module runs in the background, user's operations on other applications or programs.

13. A shooting apparatus, comprising:
a processor; and
a memory configured to store instructions that, when executed by the processor, cause the processor to execute the steps of:
starting a camera module, and entering a background shooting mode;
controlling, in the background shooting mode, the camera module to run in the background; and
receiving and executing, by the camera module running in the background, a shooting instruction.

14. The shooting apparatus according to claim 13, wherein entering the background shooting mode comprises:
automatically entering, by the camera module after being started, the background shooting mode; or,
automatically entering, by the camera module after exiting a shooting interface, the background shooting mode; or,
entering, by the camera module, the background shooting mode according to an operation instruction.

15. The shooting apparatus according to claim 13, wherein receiving and executing, by the camera module during its background running, the shooting instruction comprises:
upon triggering of a preset key, releasing, by a background control module, a broadcast according to a key triggering event; and
receiving, by the camera module running in the background, the broadcast, acquiring the key triggering event, taking the key triggering event as the shooting instruction and executing the shooting instruction.

16. The shooting apparatus according to claim 13, wherein the instructions, when executed by the processor, cause the processor to execute the step of: processing operations on other applications or programs when the camera module runs in the background.

17. The shooting apparatus according to claim 14, wherein the instructions, when executed by the processor, cause the processor to execute the step of: processing operations on other applications or programs when the camera module runs in the background.

18. The shooting apparatus according to claim 15, wherein the instructions, when executed by the processor, cause the processor to execute the step of: processing operations on other applications or programs when the camera module runs in the background.
